(19) United States
(12) Patent Application Publication
(10) Pub. No.: US 2024/0141768 A1
(43) Pub. Date: May 2, 2024

(54) DYNAMIC MANIFOLD LOCKING SYSTEM

(71) Applicant: FHE USA LLC, Fruita, CO (US)

(72) Inventors: Matthew E. Kibler, Grand Junction, CO (US); Nicolas G. Snoke, Grand Junction, CO (US); Steven M. Hutchinson, Fruita, CO (US); Kyle W. Scholl, Peoria, IL (US); Srikar S. Nittala, Grand Junction, CO (US)

(21) Appl. No.: 18/498,594

(22) Filed: Oct. 31, 2023

Related U.S. Application Data
(60) Provisional application No. 63/381,721, filed on Oct. 31, 2022.

(51) Int. Cl. E21B 43/26

(52) U.S. Cl. CPC E21B 43/2607

(57) ABSTRACT

A Dynamic Manifold Locking System (DMLS) enables remote-controlled disconnections and reconnections of pumping units from a pressurized (“hot”) fracking fluid manifold while the manifold remains pressurized and serving a well. The DMLS's connector assemblies integrate high-pressure and low-pressure connections, and remote testing of those connections, in order to enable the disconnections and reconnections of pumping units while the manifold remains pressurized. A Universal Positioning System (UPS) enables remote alignment and connection of two fluid connector assemblies integrated into the DMLS.

### RELATED APPLICATIONS

This application claims the benefit of and priority to the co-pending, commonly-invented and commonly-assigned U.S. provisional patent application Ser. No. 63/381,721 filed Oct. 31, 2022. The entire disclosure of 63/381,721 is incorporated herein by reference.

### FIELD OF THE DISCLOSURE

This disclosure relates to the field of fluid connectors, including hydraulic fracturing connectors used in subterranean “fracking” operations. More specifically, the disclosure describes embodiments of such fluid connectors useful for connecting and disconnecting pressurized fluid sources “on the fly” to and from a pressurized, multi-input fluid manifold, for example, without having to shut down and depressurize the manifold first in order to enable the connection or disconnection.

### BACKGROUND

FIGS. 1A and 1B are illustrations adapted from corresponding illustrations in U.S. Pat. No. 10,466,719, and depict conventional arrangements during a fracking stage for delivering fracking fluid (or “proppant”) to wells W on FIG. 1A, and wells W1 through W4 on FIG. 1B (wells also referred to as “wellheads”). FIGS. 1A and 1B show pressurized fluid sources such as pumping units 10 delivering fluid at pressure into manifold M1 via conventional connection arrangements 300. Pumping units 10 are illustrated on FIGS. 1A and 1B as conventional fracking fluid pump and delivery trucks, or “pumpers” as such trucks may be known colloquially.

Fluid transfer lines 20 on FIG. 1A deliver fluid from manifold M1 to manifold M2. Manifold M2 may be known colloquially as a “zipper frack” in some embodiments. Manifold M2 provides a plurality of control outputs 30. Control outputs 30 are each connected by one or more fluid delivery pipes to a “goat head” style manifold 40 atop a wellhead W.

FIG. 1B shows a Fluid Delivery Unit (“FDU”) 100 during a fracking stage receiving fluid ultimately from pumping units 10. On FIG. 1B, pumping units 10 deliver fluid at pressure into manifold M1, again via conventional connection arrangements 300. FDU 100 on FIG. 1B is configured to deliver fluid received from manifold M1 to selected wellheads W1 through W4 within reach of FDU 100. Fluid transfer lines 20 on FIG. 1B deliver fluid from manifold M1 to FDU fluid inlet 106.

FIG. 1C is a rendering of FIG. 3 in U.S. Pat. No. 10,302,079 and depicts an exemplary conventional (prior art) arrangement 300 for connecting pumping units 10 to manifold M1 on FIGS. 1A and 1B during a fracking stage. It will be seen from FIG. 1C that conventional connection arrangement 300 typically involves an arrangement of manually-connected tubular fittings. Connection arrangement 300 conventionally includes a combination of swivel joints, elbows, hammer union ends, straight joints and other flow iron to make a manual connection to manifold M1. Refer to the text of U.S. Pat. No. 10,302,079 associated with FIG. 3 thereof for a description of the manually-connected flow iron fittings also called out by the same part number on FIG. 1C.

Pumping units 10 on FIGS. 1A to 1C (as noted, typically “pumper” trucks) are typically pushed to their operational limits during a fracking stage. The nature of the existence of pumping units 10 is to perform at or near maximum capacity in order to optimize fracking costs. Eventually, however, and especially in such a high-performance environment, it becomes possible that an individual pumping unit 10 may fail during a fracking stage, or require to be changed out for maintenance. An event arises in which a pumping unit 10 must be disconnected from manifold M1 mid-stage, allowing, optimally, a replacement pumping unit 10 to be connected mid-stage to manifold M1 in its place.

Ensuring field personnel safety is a priority in fracking operations. It will be appreciated from FIG. 1C that field personnel must be physically present to assemble and disassemble the manually-connected equipment in conventional arrangement 300. It will also be understood from FIGS. 1A and 1B that pumping units 10, manifold M1, and the interconnecting fluid connections form a safety “red zone” for field personnel when manifold M1 is pressurized and fluid is moving under pressure from connected pumping units 10 into and through manifold M1. The risk of high pressure leaks or flow iron failures during high-pressure fluid transfer makes it unsafe for field personnel to be in proximity while such fluid transfer is in progress. Accordingly, field personnel are optimally restricted from entry around pumping units 10, manifold M1 and the interconnecting fluid connections during high-pressure fluid transfer operations.

Conventionally, therefore, high-pressure fluid transfer operations must be interrupted mid-stage whenever field personnel need to assemble or disassemble the manually-connected equipment illustrated on FIG. 1C. It will be appreciated from FIGS. 1A and 1B that there are multiple pumping units 10 transferring high-pressure fluid to manifold M1 during a stage. Optimally, therefore, all pumping units 10 must be shut down and manifold M1 must be depressurized each time field personnel need to enter the red zone in order to service a single connection between a pumping unit 10 and manifold M1. The mid-stage interruption causes significant additional cost to fracking operations.

Some conventional arrangements illustrated on FIGS. 1A and 1B do allow one pumping unit 10 to be replaced without shutting down all the other pumping units 10 and depressurizing manifold M1. A high pressure valve is actuated to isolate the non-functional pumping unit 10 from the rest of the system. The non-functional pumping unit 10 can then be manually disconnected from the system and a replacement re-connected. This is a dangerous operation for field personnel. Field personnel must enter the red zone to actuate the high pressure valve if the high pressure valve is manual. Regardless of whether the high pressure valve is actuated manually or remotely, field personnel must then enter the red zone to disconnect the non-functional pumping unit 10 and reconnect a replacement. The disconnect/reconnect operation relies on the integrity of the high pressure valve to assure the safety of the field personnel working in the red zone. Mistakes can be made and/or equipment may fail, putting field personnel in the red zone at risk.

Ensuring the integrity of a downhole fracking stage is also a priority in fracking operations. It was noted above that mid-stage interruptions in high-pressure fluid transfer may be necessary to ensure field personnel safety during manual service of connections between pumping units 10 and manifold M1. These interruptions may also compromise the downhole integrity of the stage. An event commonly called “sanding off” may occur, meaning that the proppant did not reach its intended destination downhole before the mid-stage interruption of flow. “Sanding off” may result in poor stage performance in the life of the well, such as reduced hydrocarbon recovery. “Sanding off” may also result in proppant getting stuck in an upper section of the borehole, requiring additional services such as coiled tubing services in order to repair the well. Such additional services are expensive and cause operational delay.

There is therefore a need in the art for a remote-controlled, high pressure connection and locking system that will permit disconnections and reconnections of pumping units from a pressurized (“hot”) manifold (for example, between pumping units 10 and manifold M1 on FIGS. 1A and 1B), without (a) causing mid-stage interruptions in high-pressure fluid transfer to the well, or (b) creating a need for field personnel to enter the safety red zone during such high-pressure fluid transfer.

### SUMMARY AND TECHNICAL ADVANTAGES

These and other needs in the prior art are addressed by a Dynamic Manifold Locking System (also referred to herein as “DMLS”). Embodiments of the DMLS are described in this disclosure. Generally, embodiments of the DMLS enable remote-controlled disconnections and reconnections of pumping units from a pressurized (“hot”) manifold while the manifold remains pressurized and serving a well. As will be described herein with reference to FIGS. 2A through 8B, the DMLS's fluid connector assemblies integrate high-pressure and low-pressure connections, and remote testing of those connections, in order to enable the disconnections and reconnections of pumping units with the manifold while the manifold remains pressurized. Further, as will be described with reference to FIGS. 9A through 9H, a Universal Positioning System (UPS) enables remote alignment and connection of two fluid connector assemblies integrated into the DMLS. A first connector assembly is on board the pumping unit and in fluid flow communication with the fluid pump system on the pumping unit. A second, mating connector assembly is attached to and in fluid communication with the manifold to which the pumping unit is desired to be remotely connected. The UPS assists with remote connection and disconnection of the first and second connector assemblies in order to enable, in part, the disconnection and reconnection of the pumping unit with the manifold while the manifold remains pressurized.

It will be appreciated that the embodiments of the DMLS, UPS and associated technology illustrated and described in this disclosure are exemplary only. The overall scope of this disclosure includes other remote connection, positioning and fluid flow control embodiments that serve an objective of remote-controlled disconnections and reconnections of pumping units from a pressurized (“hot”) manifold while the manifold remains pressurized.

It will be further appreciated that part of the control of live pumping units serving a manifold is the remote identification and recognition of specific pumping units and their monitored status to a specific physical location on the manifold relative to other pumping units. In some embodiments, this “recognition and matching” of specific units to specific location may also be termed “serializing”. Embodiments illustrated and described in this disclosure may use pairing technology such as RFID technology (for example, Bluetooth @), or frequency pulse technology to assist with serializing. The scope of this disclosure is not limited to such pairing technologies, however.

According to disclosed and illustrated embodiments, a DMLS assembly comprises a manifold stinger assembly and a hot connector assembly. The hot connector assembly is received onto the manifold stinger assembly in an “open” position. The hot connector assembly provides a plurality of locking elements rotating about locking element pins. A stinger enlarged OD section on the manifold stinger assembly engages locking element contact ribs on the locking elements as the hot connector assembly is received over the manifold stinger assembly. Engagement of the locking element contact ribs causes the locking elements to rotate, in turn causing locking element engagement surfaces to contact a stinger tapered engagement surface on the manifold stinger assembly. At this point, a stinger seal surface on the manifold stinger assembly sealingly contacts a hot connector seal surface within the hot connector assembly.

A locking ring is then brought onto the locking elements. A locking ring inner surface contacts locking element outer surfaces. Progressive engagement of the locking ring inner surface on the locking element outer surfaces causes the locking elements to constrict radially about the manifold stinger assembly. Constriction of the locking elements urges the locking element inner surfaces to tighten against a stinger tapered engagement surface on the manifold stinger assembly. At this point, the DMLS assembly is in the “closed” position. An actuator ring is then brought onto the locking elements to retain the locking elements from dilation away from the manifold stinger assembly.

Internal working pressure may then be introduced into the “closed” DMLS assembly. For example, such internal working pressure may be from a manifold to which the manifold stinger assembly is attached. Such internal pressure may urge the locking element inner surfaces on the hot connector assembly even tighter onto the stinger tapered engagement surface on the manifold stinger assembly, and may urge the locking elements even tighter onto the locking ring inner surface.

It is therefore a technical advantage of the disclosed DMLS to promote the safety of field personnel by obviating the need for field personnel to enter the safety “red zone” during high-pressure fluid transfer. Embodiments of the DMLS provide a remotely-operated and remotely-monitored fluid connector for making pressurized (or “hot”) fluid disconnections and reconnections between, for example, pumping units 10 and a manifold M1 such as illustrated on FIGS. 1A and 1B. Remotely-operated aspects of the DMLS remove the necessity for field personnel to enter the safety “red zone”. Remotely-monitored aspects of the DMLS provide automated controls configured to make checks, including redundant systems checks, to avoid human corrections errors and to optimize fluid throughput.

A further technical advantage of the disclosed DMLS is that, in currently preferred embodiments, the fluid connector flow iron is disposed to be pre-assembled before arriving at the wellsite, allowing for immediate and efficient deployment. The pre-assembled aspect allows pumping units to be switched out quickly. The pre-assembled aspect further promotes field personnel safety since field personnel may perform any manual assembly required away from the safety “red zone”. As will be described herein with reference to FIGS. 9A through 9H, embodiments of the DMLS enable robotically-controlled and electronically-aligned connections between the DMLS's fluid connector and the manifold while the manifold is still pressurized.

A further technical advantage of the disclosed fluid assembly is that its design avoids mid-stage fluid flow interruptions. As described above in the “Background” section, uninterrupted fluid flow during a stage promotes fracking efficiency both with respect to time and cost. Uninterrupted fluid flow during a stage also enhances the downhole integrity of the stage.

A further technical advantage of the disclosed DMLS is that its design promotes compliance with applicable environmental, social and governance (ESG) standards and rules. The DMLS improves the predictability of field personnel safety. The DMLS also promotes jobsite housekeeping and cleanliness. The DMLS also improves the predictability of leak-free connections, reducing the chance of environmental contamination.

In accordance with a first aspect, therefore, this disclosure describes a dynamic manifold locking system (DMLS), comprising: a stinger assembly, the stinger assembly providing separate first and second stinger flow passages therethrough, the stinger assembly further providing a stinger seal surface, the stinger assembly further providing a stinger tapered engagement surface disposed on an exterior surface of the stinger assembly; a connector assembly configured to receive the stinger assembly, the connector assembly providing separate first and second connector flow passages therethrough, the connector assembly further providing a connector seal surface, the connector assembly further providing a locking ring and a plurality of rotatable locking elements; wherein, when the stinger assembly is received inside the connector assembly such that the stinger seal surface sealingly engages the connector seal surface, extension of the locking ring causes the locking elements to constrict towards the stinger tapered engagement surface and thereby conjoin the stinger assembly within the housing assembly; wherein, responsive to said conjoining of the stinger assembly and the connector assembly, the first stinger flow passage becomes continuous with the first connector flow passage and the second stinger flow passage becomes continuous with the second connector flow passage.

In accordance with a second aspect, this disclosure describes a dynamic manifold locking system (DMLS), comprising: a stinger assembly, the stinger assembly providing separate first and second stinger flow passages therethrough, the stinger assembly further providing a stinger seal surface, the stinger assembly further providing a stinger tapered engagement surface disposed on an exterior surface of the stinger assembly; a connector assembly configured to receive the stinger assembly, the connector assembly providing separate first and second connector flow passages therethrough, the connector assembly further providing a connector seal surface, the connector assembly further providing a locking ring and a plurality of rotatable locking elements; wherein, when remotely-actuated positioning of the connector assembly causes the stinger assembly to be received inside the connector assembly such that the stinger seal surface sealingly engages the connector seal surface, extension of the locking ring causes the locking elements to constrict towards the stinger tapered engagement surface and thereby conjoin the stinger assembly within the housing assembly; wherein, responsive to said conjoining of the stinger assembly and the connector assembly, the first stinger flow passage becomes continuous with the first connector flow passage and the second stinger flow passage becomes continuous with the second connector flow passage.

In accordance with a third aspect, this disclosure describes a dynamic manifold locking system (DMLS), comprising: a stinger assembly, the stinger assembly providing separate first and second stinger flow passages therethrough, the stinger assembly further providing a stinger seal surface, the stinger assembly further providing a stinger tapered engagement surface disposed on an exterior surface of the stinger assembly; a connector assembly configured to receive the stinger assembly, the connector assembly providing separate first and second connector flow passages therethrough, the connector assembly further providing a connector seal surface, the connector assembly further providing a locking ring and a plurality of rotatable locking elements; wherein, when remotely-actuated positioning of the connector assembly causes the stinger assembly to be received inside the connector assembly such that the stinger seal surface sealingly engages the connector seal surface, remotely-actuated extension of the locking ring causes the locking elements to constrict towards the stinger tapered engagement surface and thereby conjoin the stinger assembly within the housing assembly; wherein, responsive to said conjoining of the stinger assembly and the connector assembly, the first stinger flow passage becomes continuous with the first connector flow passage and the second stinger flow passage becomes continuous with the second connector flow passage.

In some embodiments according to the first, second or third aspects, the first stinger flow passage is located centrally within the stinger assembly. In some embodiments, the second stinger flow passage is located annularly around the first stinger flow passage.

In some embodiments according to the first, second or third aspects, the first stinger flow passage is configured to transfer fluid at a different pressure than fluid transferred in the second stinger flow passage.

In some embodiments according to the first, second or third aspects, the connector assembly further includes an actuator ring and plurality of rotatable actuator elements, and in which extension of the actuator ring causes the actuator elements to constrict towards the locking elements and thereby retain the locking elements. In some embodiments, the actuator ring is remotely actuated.

In some embodiments according to the first or second aspects, extension of the locking ring is actuated remotely.

The foregoing has outlined rather broadly some of the features and technical advantages of the technology embodied in the disclosed DMLS designs, in order that the detailed description that follows may be better understood. Additional features and advantages of the disclosed technology may be described. It should be appreciated by those skilled in the art that the conception and the specific embodiments disclosed may be readily utilized as a basis for modifying or designing other structures for carrying out the same inventive purposes of the disclosed technology, and that these equivalent constructions do not depart from the spirit and scope of the technology as described.

### BRIEF DESCRIPTION OF THE DRAWINGS

For a more complete understanding of embodiments described in detail below, and the advantages thereof, reference is now made to the following drawings, in which:

FIGS. 1A, 1B and 1C depict prior art fluid connection arrangements as described in more detail in the “Background” section above;

FIG. 2A is an adapted view of FIG. 1B, in which embodiments of DMLS assemblies 400 are deployed on FIG. 2A to connect pumping units 10 to manifold M1;

FIG. 2B is similar to FIG. 2A, in which one of the pumping units 10 has been disconnected from manifold M1;

FIG. 3 is a block diagram rendering of FIG. 2A illustrating flowpaths on FIG. 2A schematically;

FIG. 4 illustrates schematically an embodiment of interconnections of equipment, fittings and controls to enable remote disconnection and reconnection of pumping unit 10 from manifold M1 while manifold M1 remains pressurized;

FIG. 5 is an enlargement from FIG. 2A illustrating embodiments of DMLS assemblies 400 deployed to connect pumping units 10 to manifold M1 in more detail;

FIG. 6 is an elevation view of an embodiment of a single DMLS assembly 400 deployed to connect a pumping unit 10 to manifold M1;

FIG. 7 is an exploded partial section view of an embodiment of DMLS assembly 400;

FIGS. 8A and 8B are section views of DMLS assembly 400 from FIG. 7, with hot connector assembly 450 shown fully disconnected from manifold stinger assembly 410 in FIG. 8A and fully connected in FIG. 8B;

FIG. 9A illustrates perspective and elevation views of an embodiment of universal positioning system (UPS) assembly 500 deployed on the embodiment of hot connector assembly 450 of FIGS. 8A and 8B;

FIGS. 9B, 9C and 9D illustrate UPS assembly 500 from FIG. 9A setting hot connector assembly 450 in various positional states of extension and retraction to assist remote connection to manifold stinger assembly 410 (omitted for clarity);

FIGS. 9E, 9F, 9G and 9H illustrate UPS assembly 500 from FIG. 9A setting hot connector assembly 450 in various vertical/horizontal positional states to assist remote connection to manifold stinger assembly 410 (omitted for clarity);

FIG. 10A is a flow chart illustrating an exemplary procedure disconnecting a pumping unit 10 from manifold M1 in accordance with embodiments described in this disclosure;

FIG. 10B is a flow chart illustrating an exemplary procedure connecting a pumping unit 10 to manifold M1 in accordance with embodiments described in this disclosure;

FIG. 11A is a flow chart illustrating disconnection of DMLS 400 (disconnection of hot connector assembly 450 from manifold stinger assembly 410); and

FIG. 11B is a flow chart illustrating connection of DMLS 400 (connection of hot connector assembly 450 to manifold stinger assembly 410).

### DETAILED DESCRIPTION

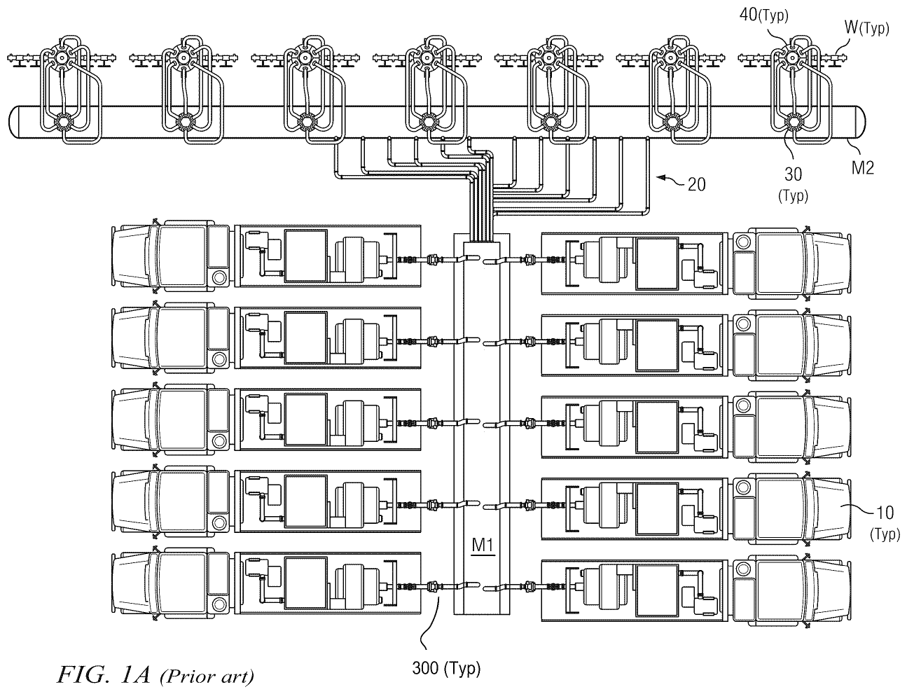

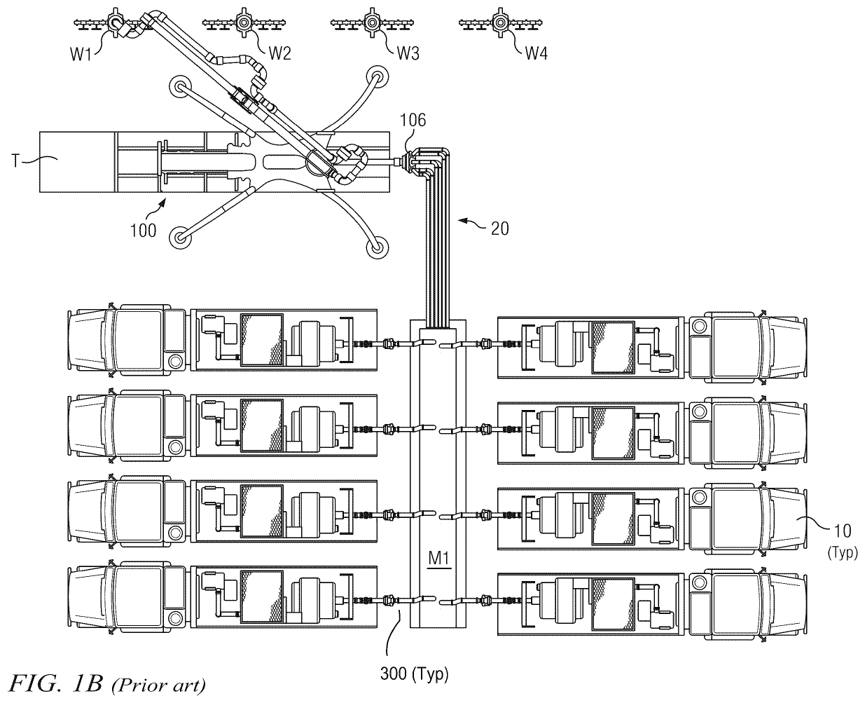

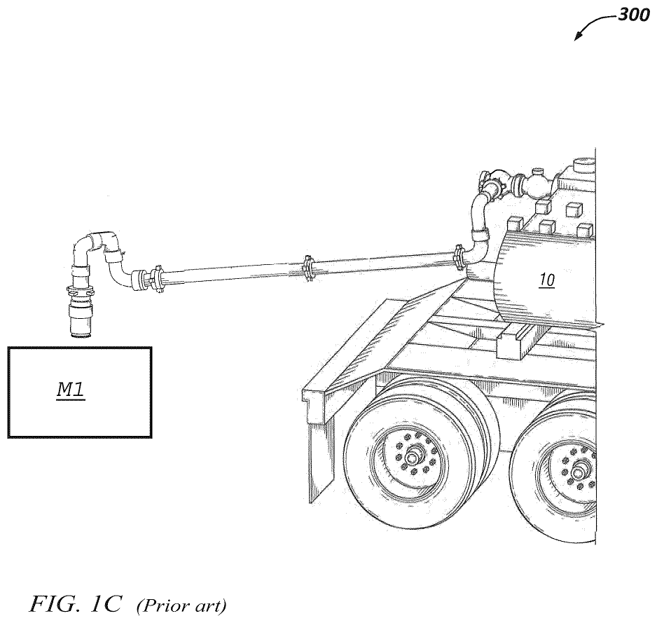

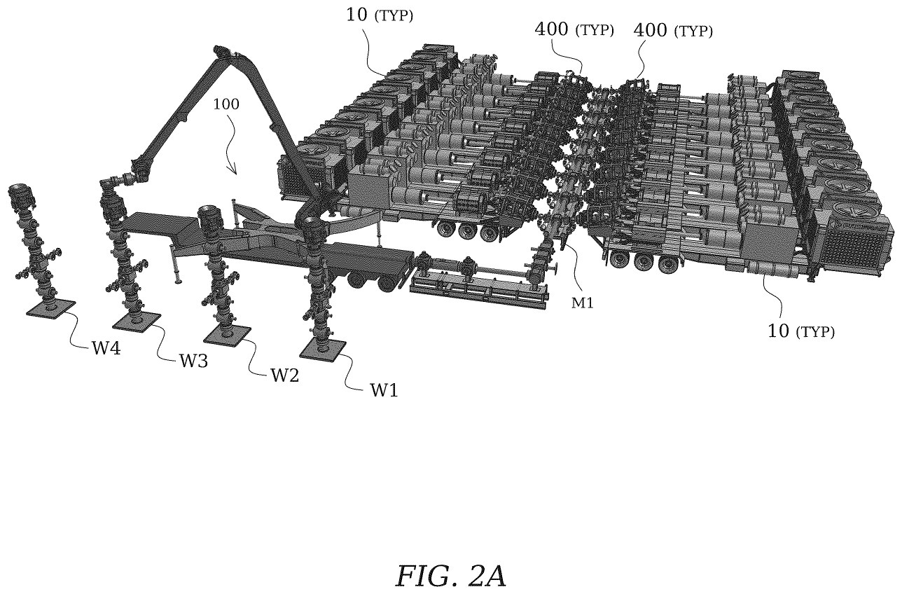

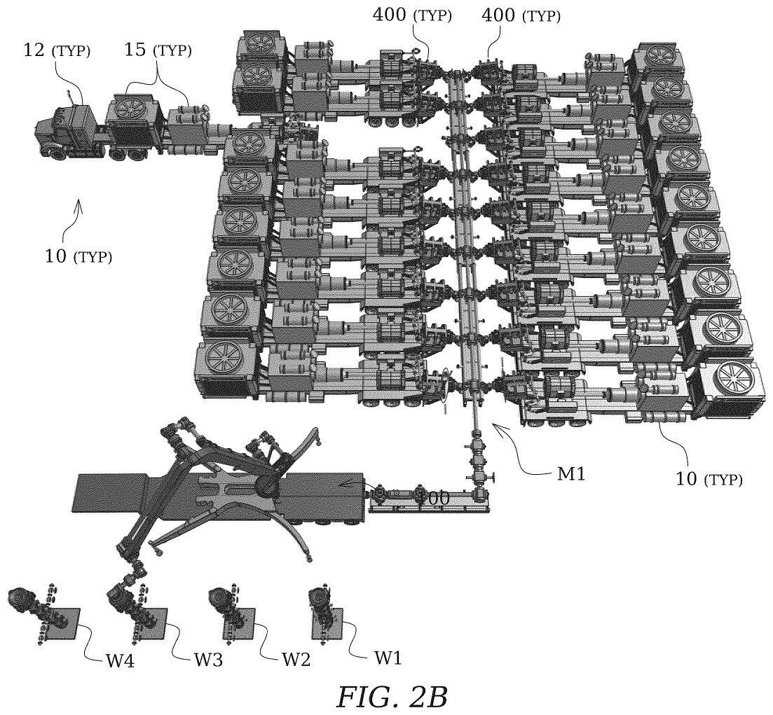

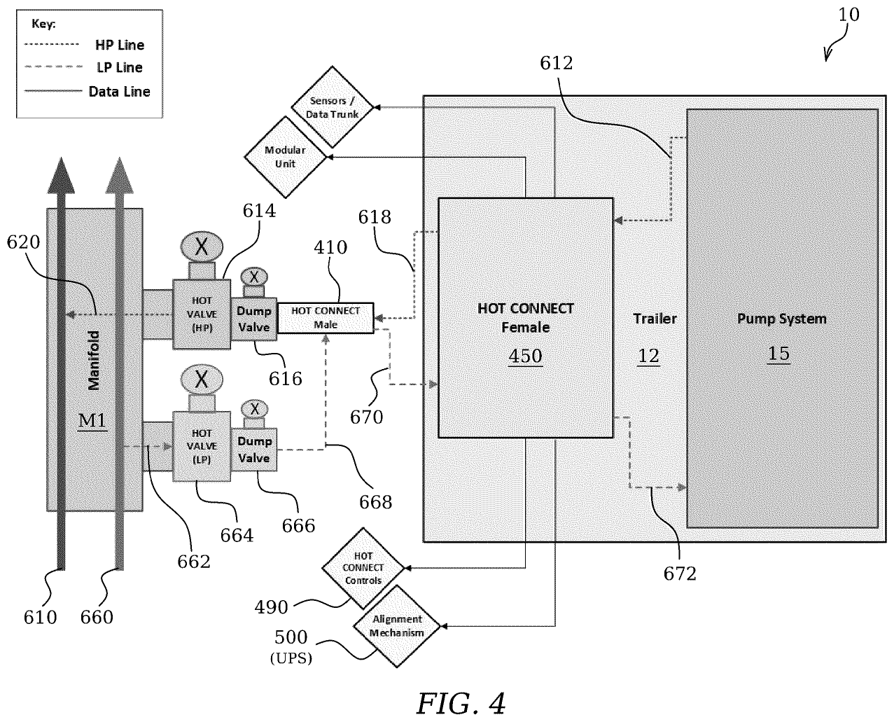

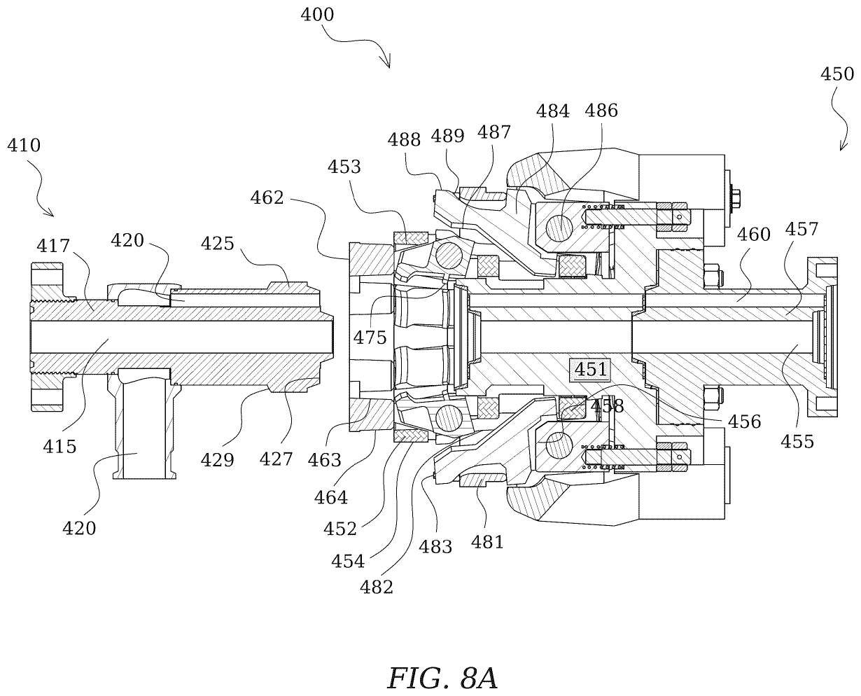

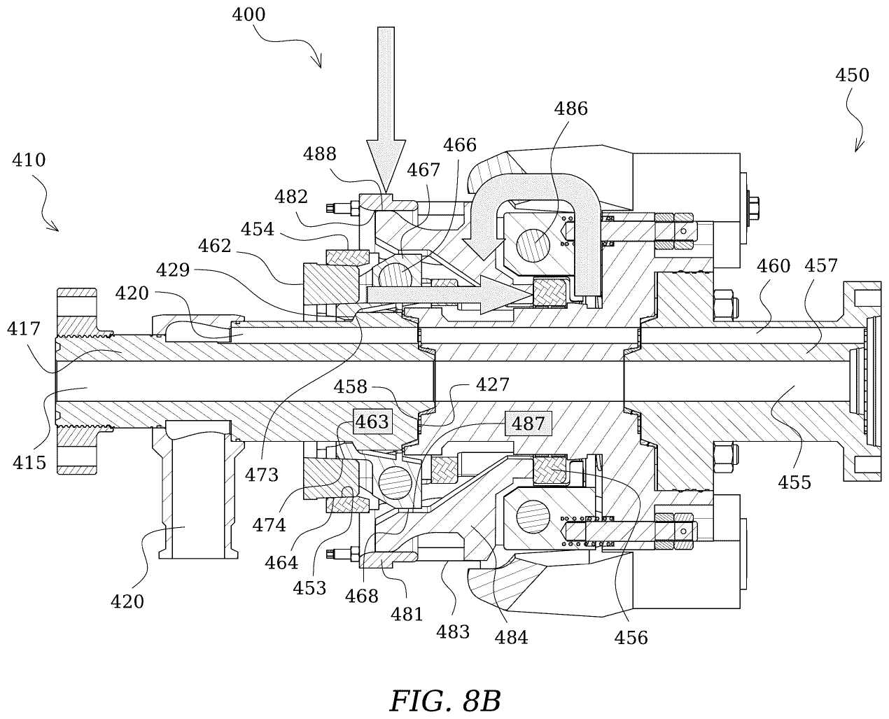

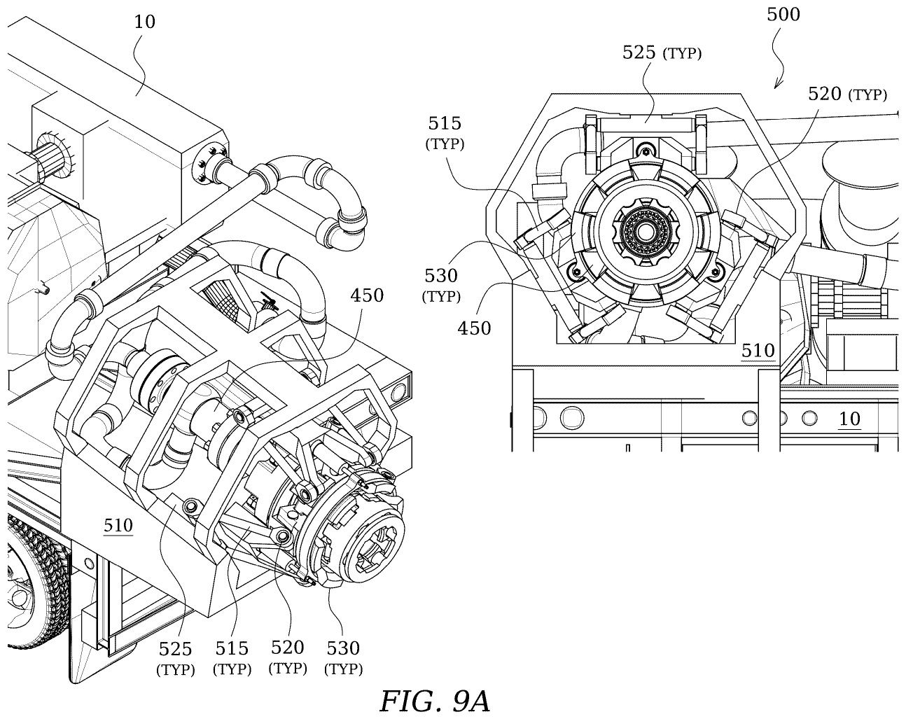

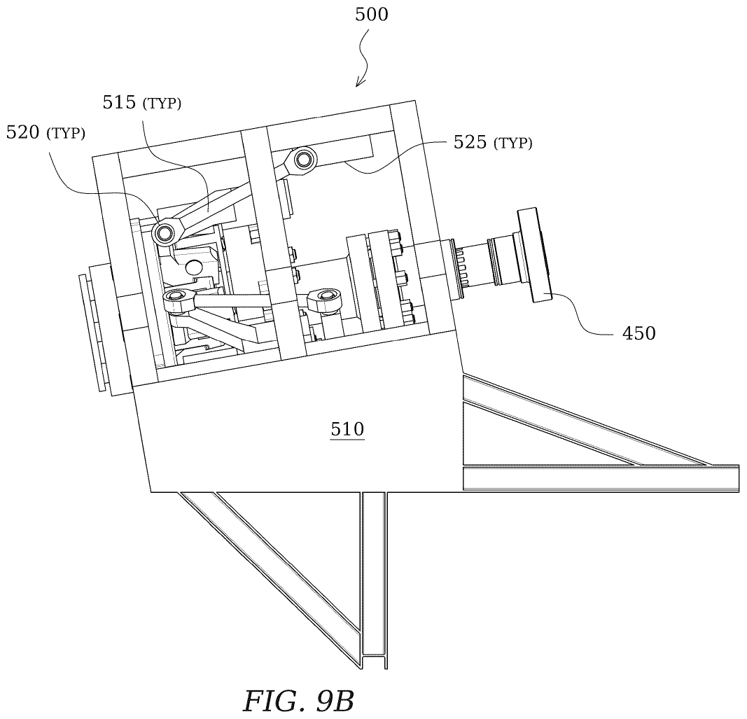

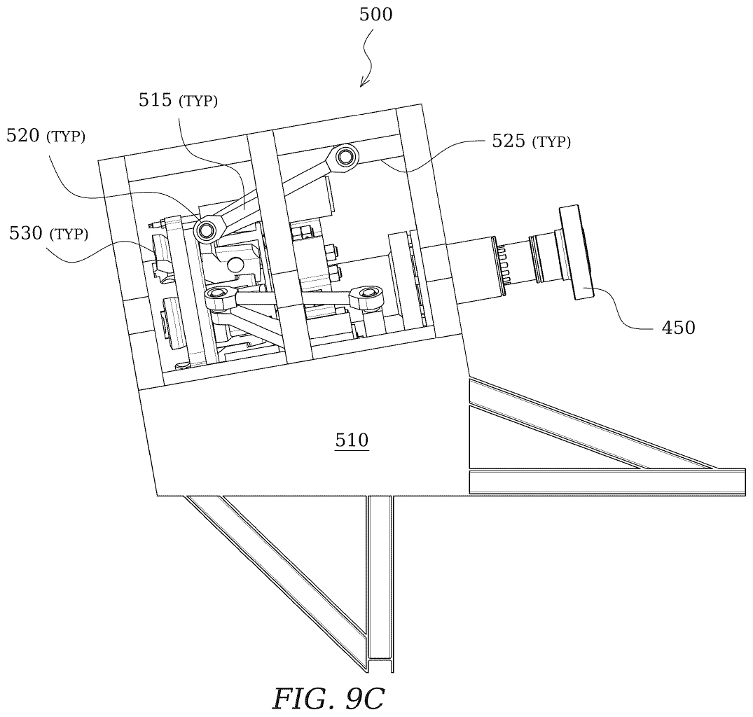

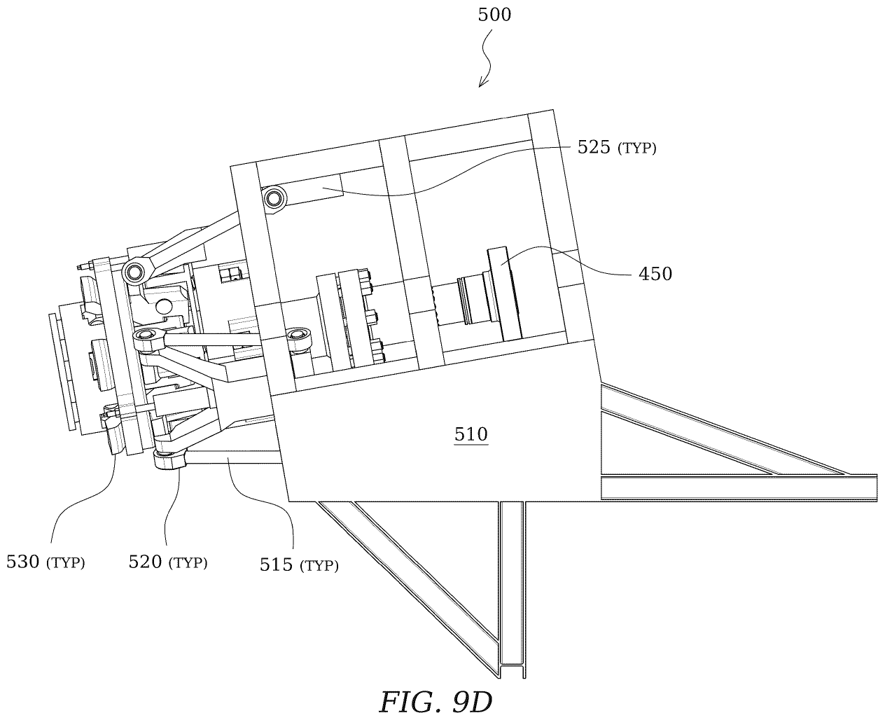

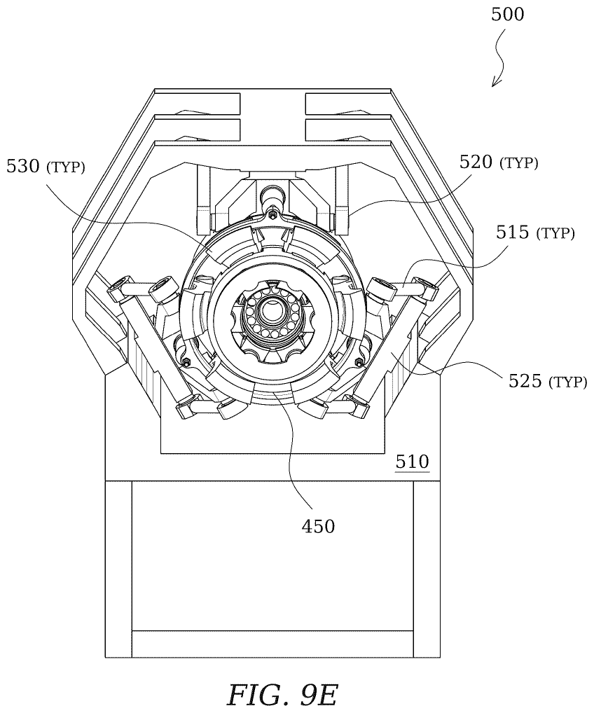

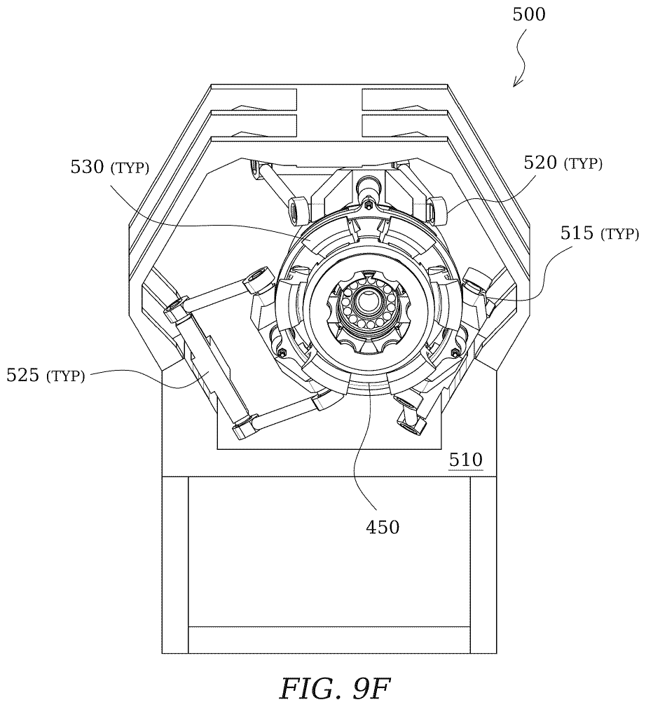

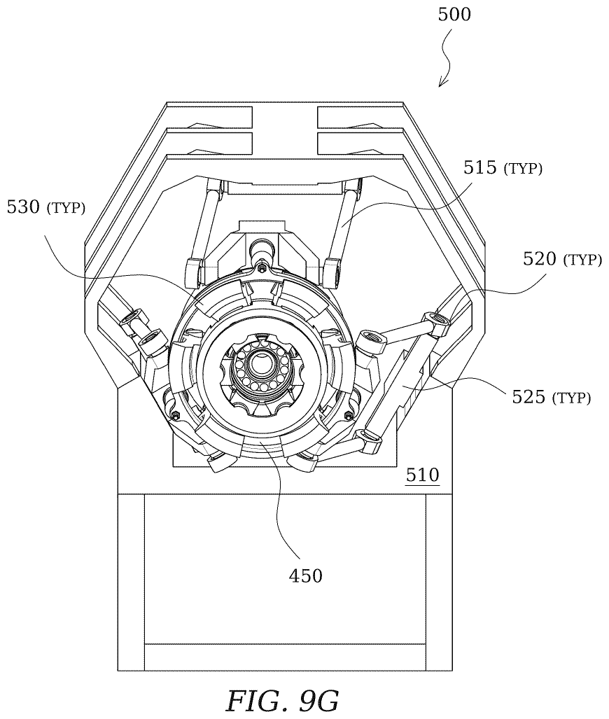

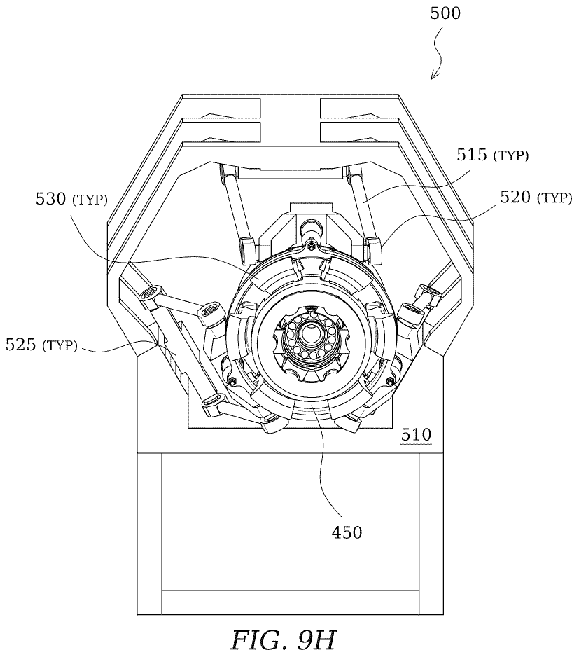

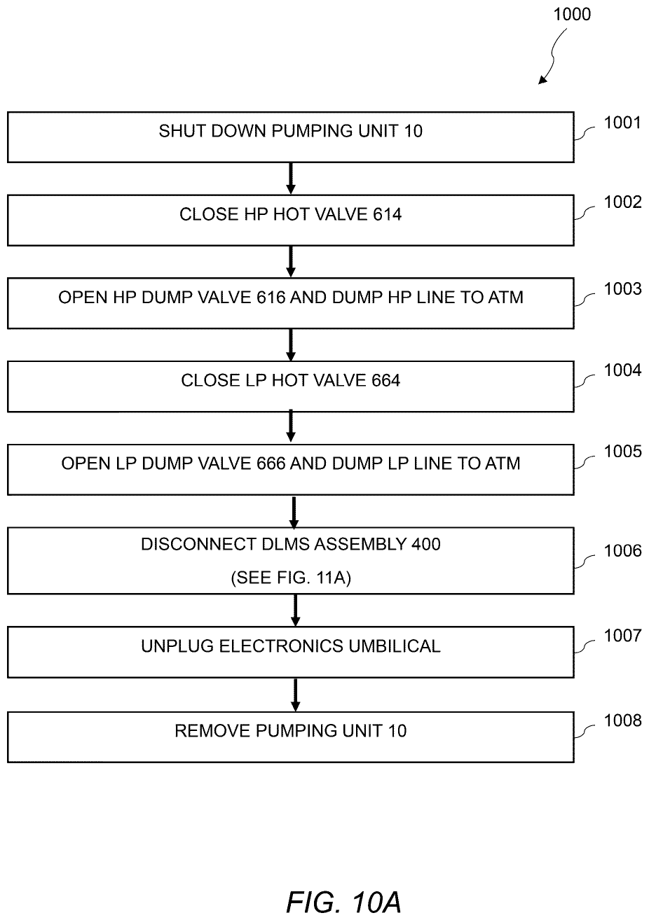

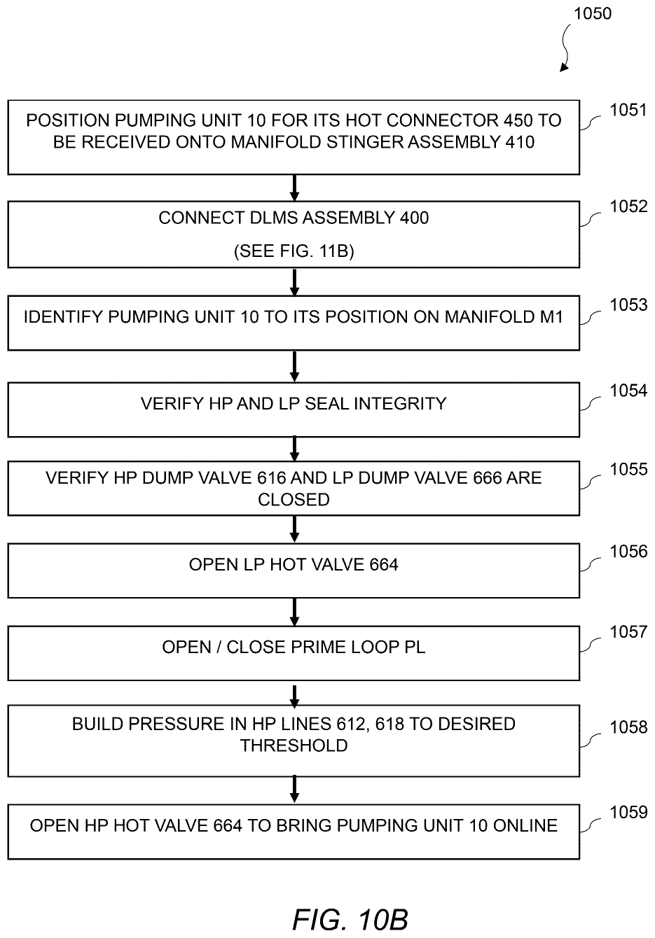

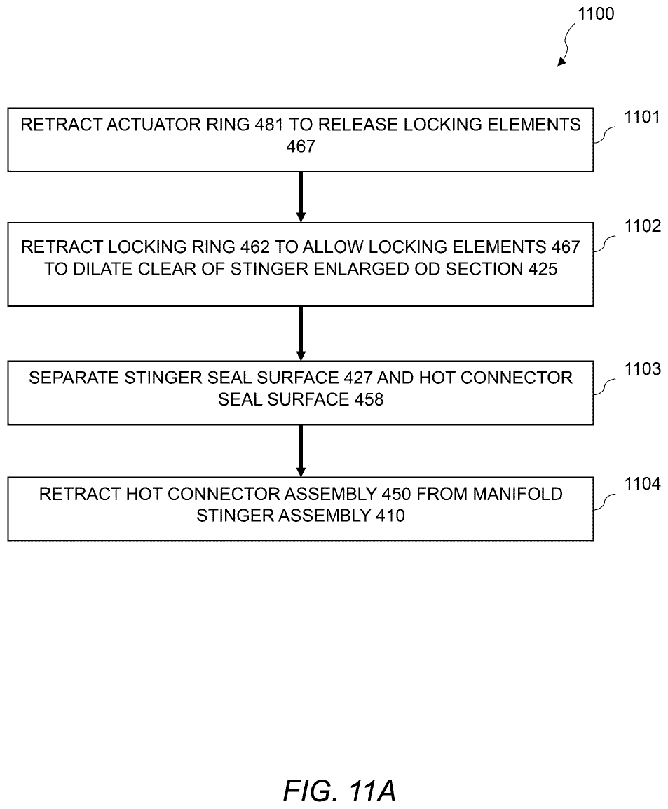

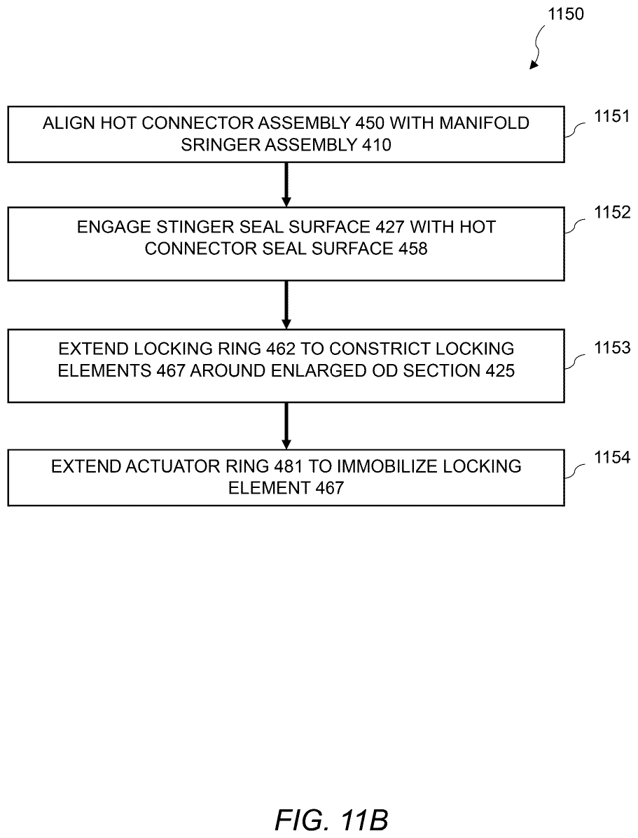

Reference is now made to FIGS. 1A through 11B as listed above in describing embodiments of the disclosed fluid connections. For the purposes of the following disclosure, FIGS. 1A through 1C depict prior art connection arrangements. FIGS. 2A through 8B, 9A through 9H, and 10A through 11B depict embodiments of new fluid connection designs. FIGS. 2A through 8B should be viewed together, and FIGS. 9A through 9H should be viewed together with further reference to FIGS. 2A through 8B. FIGS. 10A through 11B should be viewed together with reference to other Figures, particularly FIGS. 4, 8A and 8B. Any part, item, or feature that is identified by part number on one of FIGS. 1A through 1C, 2A through 8B, 9A through 9H, and 10A through 11B as listed above will have the same part number when illustrated on another of FIGS. 1A through 1C, 2A through 8B, 9A through 9H, and 10A through 11B. It will be understood that the embodiments as illustrated and described with respect to FIGS. 2A through 11B are exemplary, and the scope of this disclosure is not limited to such illustrated and described embodiments.

FIGS. 1A, 1B and 1C depict prior art fluid connection arrangements as described in more detail in the “Background” section above.

FIG. 2A is an adapted view of FIG. 1B, in which DMLS assemblies 400 are deployed on FIG. 2A to connect pumping units 10 to manifold M1 instead of conventional connection arrangements 300 as shown on FIGS. 1B and 1C.

FIG. 2B is similar to FIG. 2A. In FIG. 2B, one of the pumping units 10 has been disconnected from manifold M1 in a manner consistent with description further below with reference to additional Figures. High-pressure flow of proppant from manifold M1 to FDU 100 has not been interrupted on FIG. 2B as a result of disconnection of the removed pumping unit 10. As noted above, embodiments of DMLS assembly 400 as described in this disclosure are configured to enable safe, remote disconnection and reconnection of pumping units 10 from manifold M1 without having to depressurize manifold M1.

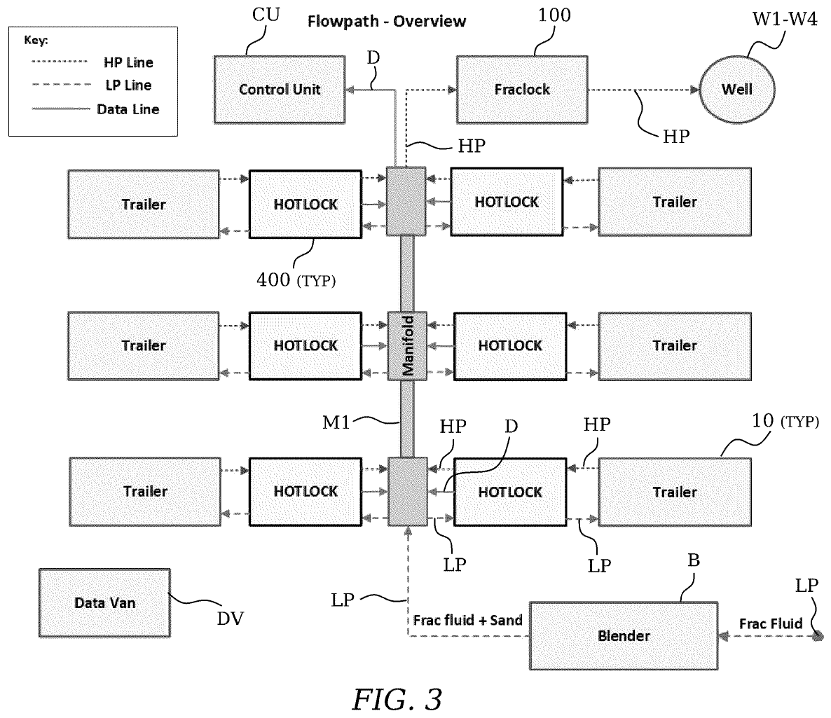

FIG. 3 is a block diagram rendering of FIG. 2A illustrating flowpaths on FIG. 2A schematically. FIG. 3 depicts pumping units 10 (also “Trailer” on FIG. 3) connected to manifold M1 via DMLS assemblies 400 (also “HotLock” on FIG. 3). FIG. 3 also depicts a conventional blender unit B, configured to blend fracking fluid and sand into proppant and deliver same at low pressure to low pressure manifold piping associated with manifold M1. FIG. 3 illustrates each pumping unit 10 deployed to receive proppant from manifold M1 via DMLS assembly 400 at low pressure (“LP” shown in dashed broken line on FIG. 3). FIG. 3 further illustrates each pumping unit 19 deployed to deliver the proppant back to manifold M1 via DMLS assembly 400 at high pressure (“HP” shown in dotted broken line on FIG. 3).

FIG. 3 further depicts manifold M1 delivering high pressure proppant from all contributing pumping units 10 to FDU 100 (also “FracLock/FracBoom” on FIG. 3). FDU 100 on FIG. 3 then delivers the high pressure proppant selectively to wells W1 to W4.

FIG. 3 also illustrates data lines D between each DMLS assembly 400 and manifold M1, and between manifold M1 and control unit CU (“D” shown in solid line on FIG. 3). FIG. 3 also illustrates data van DV, which in some deployments may be a convenient jobsite control room for field personnel to control flow of proppant through manifold M1 at a safe distance. Data van DV optimally receives sensed information carried on data lines D shown on FIG. 3 and then sends responsive instructions back via data lines D. Data van DV may be functionally linked to control unit CU in deployments where CU is not physically adjacent or integrated into data van DV.

It will be appreciated from FIG. 3 that DMLS assemblies 400 integrate both high pressure and low pressure proppant flow between manifold M1 and pumping units 10. As will be described below with reference to additional Figures, this integration of high pressure and low pressure flow in one DMLS assembly 400 contributes the DMLS assembly 400's provision of safe, remote disconnection and reconnection of pumping units 10 from manifold M1 without having to interrupt a fracking stage to depressurize manifold M1.

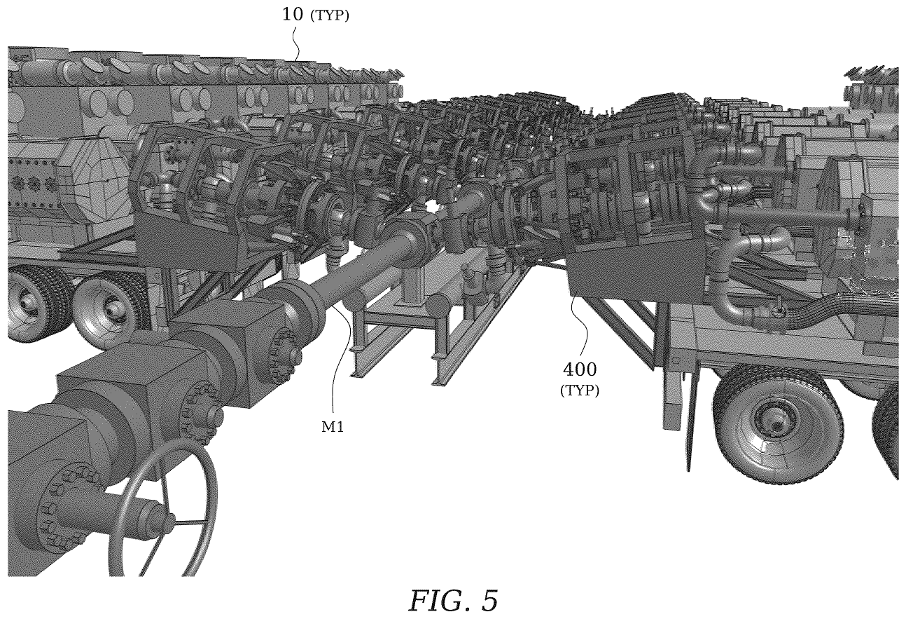

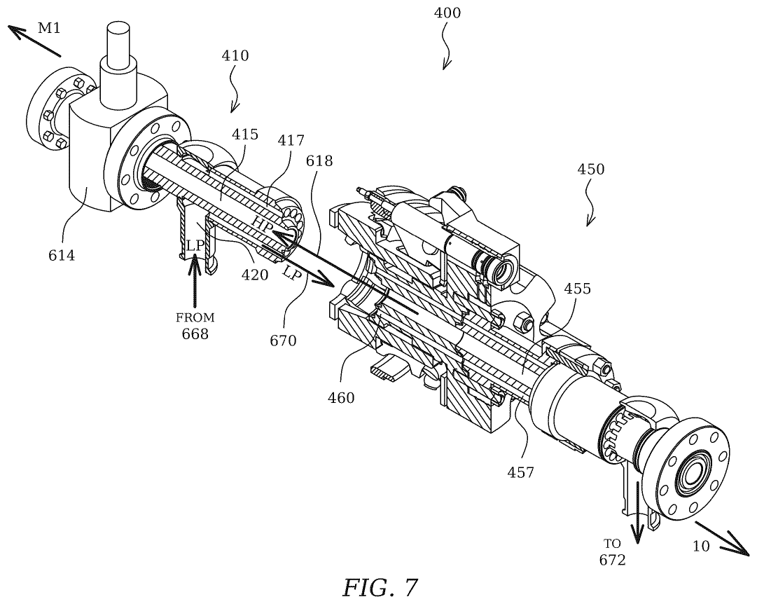

FIG. 4 illustrates schematically an embodiment of interconnections of equipment, fittings and controls to enable remote fluid disconnection and reconnection of pumping unit 10 from manifold M1 without having to depressurize manifold M1. Subject matter depicted on FIG. 4 corresponds approximately to less schematic depictions on FIGS. 5, 6 and 7. Pumping unit 10 on FIG. 4 includes trailer 12 and pump system 15. Referring momentarily to FIG. 7, DMLS assembly 400 includes manifold stinger assembly 410 and hot connector assembly 450. FIG. 4 depicts hot connector assembly 450 (“Hot Connect Female”) on board trailer 12 of pumping unit 10 and in fluid flow communication with pumping system 10. FIG. 4 depicts manifold stinger assembly 410 (“Hot Connect Male”) ultimately connected to manifold M1 via HP hot valve 614 and HP dump valve 616. It will be understood on FIG. 4 that the connection of hot connector assembly 450 and manifold stinger assembly 410 enables both high pressure (HP) and low pressure (LP) fluid communication between pumping unit 10 and manifold M1.

Much of the subject matter depicted on the embodiment of FIG. 4 is described below in greater detail with reference to embodiments shown in FIGS. 7, 8A and 8B, and 9A through 9H. Further, the subject matter depicted on FIG. 4 supports the exemplary disconnect and reconnect sequences described further on in this disclosure and illustrated with reference to FIGS. 10A through 11B.

Looking at FIG. 4 in detail, manifold M1 includes manifold HP supply 610 and manifold LP return 660. It will be understood that manifold HP supply 610 is fluid ultimately destined for the well, and manifold LP return 660 is fluid ultimately returned from the well. As shown on the key on FIG. 4, dotted broken lines on FIG. 4 indicate high pressure fluid flow, dashed broken lines on FIG. 4 indicate low pressure fluid flow, and solid lines on FIG. 4 indicate data communication. Looking at low pressure equipment and connections first, LP line A (662) taps into LP return 660 and delivers low pressure fluid to manifold stinger assembly 410 via LP hot valve 664, LP dump valve 666 and LP line B (668). Once manifold stinger assembly 410 is operationally connected to hot connector assembly 450, low pressure fluid passes through the connected assemblies via LP line C (670) and then returns to pump system 15 via LP line D (672). Low pressure fluid flow through manifold stinger assembly 410 and hot connector assembly 450 is described in more detail below with reference to embodiments shown on FIG. 7.

FIG. 4 further shows pump system 15 initially delivering high pressure fluid via HP line A (612). Once manifold stinger assembly 410 is operationally connected to hot connector assembly 450, high pressure fluid passes through the connected assemblies via HP line B (618). High pressure fluid flow through manifold stinger assembly 410 and hot connector assembly 450 is described in more detail below with reference to embodiments shown on FIG. 7. FIG. 4 illustrates HP line C (620) tapping into manifold HP supply 610. High pressure fluid flows from manifold stinger assembly 410 into manifold supply 610 via HP dump valve 616, HP hot valve 614 and HP line C (620).

Reference should ideally now be made to the exemplary disconnect and reconnect sequences described further on in this disclosure in order to appreciate the interconnection of equipment and features on FIG. 4. It should also be noted that the reconnect sequence below refers to Prime Loop PL, which is not specifically called out on FIG. 4 for clarity. However, Prime Loop PL refers schematically on FIG. 4 to LP lines A-D (662, 668, 670, 672) and HP lines A-B (612, 618). That stated, the concept of a prime loop as described in this disclosure is not limited to a specific loop such as depicted on FIG. 4. The technology described herein recognizes that fluid lines will require priming when a replacement pumping unit 10 is being reconnected to manifold M1 with manifold M1 at operating pressure. The scope of this disclosure is not limited to the manner in which such priming is enabled.

FIG. 4 is also illustrated with one (1) HP hot valve 614 illustrated. Some deployments may call for an additional, redundant HP hot valve included in the high pressure flow line for safety, such that if one valve fails, the other will prevent an unintended leak of high pressure fluid from manifold M1 once a hot disconnect is made.

FIG. 4 also shows DMLS controls 490 (“Hot connect controls”) functionally connected to hot connector assembly 450. DMLS controls 490 on FIG. 4 represent functionally the remote locking and unlocking of hot connector assembly 450 to and from manifold stinger assembly 410, such as described in more detail below with reference to embodiments shown on FIGS. 8A and 8B.

FIG. 4 also shows Universal Positioning System (UPS) 500 (“Alignment mechanism”) functionally connected to hot connector assembly 450. UPS 500 on FIG. 4 represents functionally the remote alignment of hot connector assembly 450 with manifold stinger assembly 410, such as described in more detail below with reference to embodiments shown on FIGS. 9A through 9H.

FIG. 4 also shows “Modular Unit” functionally connected to hot connector assembly 450. Modular Unit on FIG. 4 represents functionally that DMLS 400 and its associated sensors, fittings, etc. are modular and may be retrofitted onto existing trailers 12 on pumping units 10. The scope of this disclosure includes purpose-built pumping units 10 and retrofitted pumping units 10 characterized for DMLS service according to this disclosure.

FIG. 4 also shows “Sensors/Data Trunk” functionally connected to hot connector assembly 450. Sensors/Data Trunk on FIG. 4 represents functionally the ancillary sensing and data acquisition going on during disconnection and reconnection of pumping units 10 from manifold M1 according to this disclosure. Examples of such ancillary sensing and data acquisition are described below with reference to an exemplary disconnect and reconnect sequence (e.g. tasks in sequence requiring “verification” or “addressing”).

FIG. 5 is an enlargement from FIG. 2A illustrating embodiments of DMLS assemblies 400 deployed to connect pumping units 10 to manifold M1 in more detail.

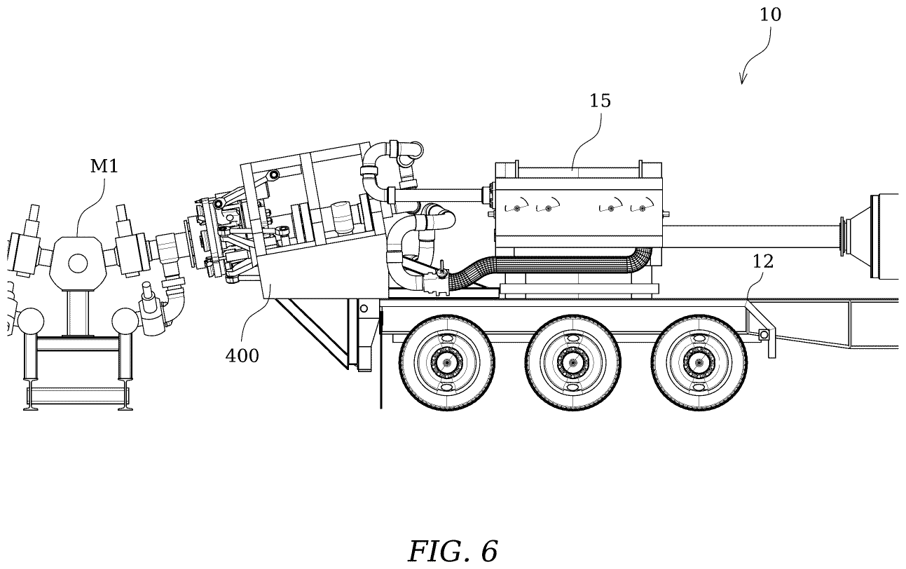

FIG. 6 is an elevation view of an embodiment of a single DMLS assembly 400 deployed to connect a pumping unit 10 to manifold M1.

FIG. 7 is an exploded partial section view of an embodiment of DMLS assembly 400. DMLS assembly 400 on FIG. 7 includes two cooperating subassemblies: manifold stinger assembly 410 and hot connector assembly 450. FIG. 7 further shows manifold stinger assembly 410 configured to be connected to manifold M1 via HP hot valve 614 (per FIG. 4 or 6, for example), and hot connector assembly 450 configured to be connected to pumping unit 10 (also per FIG. 4 or 6, for example). In some exemplary embodiments, high pressure fluid flow may be at least about 130 gallons per minute, preferably at about 10,000 psi and more preferably at about 15,000 psi. Low pressure fluid flow may be at least about 260 gallons per minute, preferably at about 100 psi and more preferably at about 300 psi.

In summary, the embodiment of DMLS assembly 400 on FIG. 7 shows manifold stinger assembly 410 as a unitary combined high pressure/low pressure insert connection with independent high pressure and low pressure flow lines on board. Insertion of manifold stinger assembly 410 into hot connector assembly 450 initializes concurrent connection of the high pressure and low pressure lines into hot connector assembly 450. FIG. 7 shows manifold stinger assembly 410 and hot connector assembly 450 each providing cooperating first flow passages 415, 455 therethrough, such that first flow passages 415, 455 are configured to be continuous responsive to conjoining of manifold stinger assembly 410 and hot connector assembly 450. First flow passages 415, 455 are advantageously for transfer of high pressure fluid from pumping unit 10 to manifold M1 in embodiments illustrated on FIG. 7. FIG. 7 further shows manifold stinger assembly 410 and hot connector assembly 450 each providing cooperating second flow passages 420, 460 therethrough, such that second flow passages 420, 460 are configured to be continuous responsive to conjoining of manifold stinger assembly 410 and hot connector assembly 450. Second flow passages 420, 460 are advantageously for return of low pressure fluid in embodiments illustrated on FIG. 7. In embodiments of DMLS assembly 400 shown on FIG. 7, high pressure flow passages 415, 455 are cooperating central axial passages in manifold stinger assembly 410 and hot connector assembly 450 respectively, and low pressure flow passages 420, 460 are cooperating annular passages in manifold stinger assembly 410 and hot connector assembly 450 respectively. Annular barriers 417, 457 separate high pressure flow passages 415, 455 from low pressure flow passages 420, 460 on manifold stinger assembly 410 and hot connector assembly 450 respectively. It will nonetheless be understood that the respective central and annular locations of high pressure flow passages 415, 455 and low pressure flow passages 420, 460 within manifold stinger assembly 410 and hot connector assembly 450 are exemplary only, and the scope of this disclosure is not limited in this regard. Other, non-illustrated embodiments may separate first flow passages 415, 455 from second flow passages 420, 460 via other relative locations and orientations within manifold stinger assembly 410 and hot connector assembly 450.

FIGS. 8A and 8B are section views of DMLS assembly 400 from FIG. 7, with hot connector assembly 450 shown fully disconnected from manifold stinger assembly 410 in FIG. 8A and fully connected in FIG. 8B. FIGS. 8A and 8B should be viewed together in order to see all the components and features labeled on the Figures. Not all parts and features are labeled on both Figures, for clarity. Some parts and features are labeled on both, some are labeled on FIG. 8A only and others are labeled on FIG. 8B only. FIGS. 8A and 8B together illustrate the following parts and features:
DMLS assembly 400
Manifold stinger assembly 410
High pressure flow passage 415
Annular barrier 417
Low pressure flow passage 420
Stinger enlarged OD section 425
Stinger seal surface 427
Stinger tapered engagement surface 429
Hot connector assembly 450
Hot connector body 451
Castle 452
Castle inner surface 453
Castle outer surface 454
High pressure flow passage 455
Hot connector actuator stop 456
Annular barrier 457
Hot connector seal surface 458
Low pressure flow passage 460
Locking ring 462
Locking ring inner surface 463
Locking ring outer surface 464
Locking element pin 466
Locking element 467
Locking element retaining surface 468
Locking element engagement surface 473
Locking element outer surface 474
Locking element contact rib 475
Actuator ring 481
Actuator ring inner surface 482
Actuator ring piston 483
Actuator element 484
Actuator element pin 486
Actuator element inner surface 487
Actuator element outer surface 488
Actuator element constricting surface 489

Referring back momentarily to FIGS. 6 and 7, it will also be appreciated on FIGS. 8A and 8B that manifold stinger assembly 410 is disposed to be connected to manifold M1, and hot connector assembly 450 is disposed to be connected to pumping unit 10. In embodiments shown on FIGS. 6 and 7, manifold stinger assembly 410 is fixed to manifold M1 and hot connector assembly 450 is disposed to displaced (extended and retracted) towards and away from manifold stinger assembly 410 in order to form connections and disconnections of DMLS assembly 400 as a whole.

Connection (coupling) of hot connector assembly 450 to manifold stinger assembly 410 will now be described with reference to FIGS. 8A and 8B together. Referring first to FIG. 8A, locking elements 467 are disposed to rotate about locking element pins 466. A spring bias (omitted for clarity) preferably encourages locking elements 467 to remain in a default dilated (or “unconstricted”) position about locking element pins 466 as shown on FIG. 8A. Manifold stinger assembly 410 is received into hot connector assembly 450 as hot connector assembly 450 is extended towards manifold stinger assembly. Stinger enlarged outside diameter (OD) section 425 contacts locking element contact ribs 475 and causes locking elements 467 to rotate and constrict towards stinger enlarged OD section 425. Referring now to FIG. 8B, locking elements 467 reach near full rotation and constriction when stinger seal surface 427 contacts and sealingly engages hot connector seal surface 458 and locking element engagement surfaces 473 oppose stinger tapered engagement surfaces 429 on the exterior surface of manifold stinger assembly 410.

Locking ring 462 is now extended to bear upon locking elements 467 and cause further constriction of locking elements 467 towards stinger enlarged OD section 425. FIG. 8A shows locking ring 462 in a retracted state and FIG. 8B shows locking ring 462 in an extended state. Locking ring 462 is disposed to be extended and retracted by conventional mechanisms that are omitted from FIGS. 8A and 8B for clarity. Such conventional mechanisms may include hydraulic or pneumatic actuators such as pistons, or threaded actuators, for example.

Extension of locking ring 462, as shown in the transition from FIG. 8A to 8B, conjoins and advantageously locks the connection of hot connector assembly 450 to manifold stinger assembly 410 and forms a high pressure fluid seal between stinger seal surface 427 and hot connector seal surface 458. Locking ring inner and outer surfaces 463, 464 are preferably sloped, and bear increasingly upon locking element outer surfaces 474 and castle inner surface 453 as locking ring 462 is extended. Increasing extension of locking ring 462, per FIG. 8B, forces locking element engagement surfaces 473 to constrict further against stinger tapered engagement surfaces 429. Locking element engagement surfaces 473 and stinger tapered engagement surfaces 429 preferably provide cooperating slopes such that, responsive to increasing extension of locking ring 462, further constriction of locking element surfaces 473 causes corresponding increased compression of stinger seal surface 427 against hot connector seal surface 458, tightening the seal between stinger seal surface 427 and hot connector seal surface 458.

The interface between stinger seal surface 427 and hot connector seal surface 458 may also provide additional features to enhance the integrity of the seal formed between stinger seal surface 427 and hot connector seal surface 458. Such additional features may include o-rings, gaskets, and/or high tolerance machined surfaces on seal surfaces, for example. In preferred embodiments, the seal formed between stinger seal surface 427 and hot connector seal surface 458 is rated to retain up to 15 ksi pressure in high pressure flow passages 415, 455. The seal formed between stinger seal surface 427 and hot connector seal surface 458 may require high tolerance machined metal-metal contact in order to retain up to 15 ksi pressure.

Actuator ring 484 is now extended to further retain locking elements 467. Referring back to FIG. 8A, actuator elements 484 are disposed to rotate about actuator element pins 486. A spring bias (omitted for clarity) preferably encourages actuator elements 484 to remain in a default dilated (or “unconstricted”) position about actuator element pins 486 as shown on FIG. 8A. Actuator ring pistons 483 are disposed to extend and retract actuator ring 481. Extension and retraction of actuator ring 481 causes actuator elements 484 to rotate and constrict responsive to contact between actuator ring 481 and actuator element constricting surfaces 489. Referring now to FIG. 8B, actuator ring pistons 483 have extended actuator ring 481. Actuator elements 484 reach full rotation and constriction when actuator elements 484 contact hot connector actuator stops 456 and actuator ring inner surface 482 opposes actuator element outer surfaces 488. At this point, actuator element inner surfaces 487 oppose locking element retaining surfaces 468 and retain locking elements 467 such that locking element engagement surfaces 473 are held in opposition to stinger tapered engagement surfaces 429.

Disconnection (decoupling) of hot connector assembly 450 from manifold stinger assembly 410 is essentially the reverse of connection. Actuator ring 481 is retracted via retraction of actuator pistons 483. Retraction of actuator ring 481 allows actuator elements 484 to dilate away from locking elements 467, thereby releasing locking elements 467 from retention. Dilation of actuator elements 484 is by rotation about actuator element pins 486 back towards a default position as shown on FIG. 8A. As noted above, a spring bias (omitted for clarity) preferably encourages the dilation of actuator elements 484 away from locking elements 467. Locking ring 462 is then retracted, allowing locking elements 467 to dilate. Dilation of locking elements 467 is by rotation about locking element pins 466 back towards a default position as shown on FIG. 8A. As noted above, a spring bias (omitted for clarity) preferably encourages the dilation of locking elements 467. DMLS 400 is ready for disconnection once locking elements 467 dilate clear of stinger enlarged OD section 425. The seal between stinger seal surface 427 and hot connector seal surface 458 may be released. Hot connector assembly 450 may then be retracted from manifold stinger assembly 410.

It will be appreciated from the foregoing description of FIGS. 8A and 8B that the connection and disconnection of DMLS 400 is configured to be enabled remotely. Locking ring 462 and actuator ring pistons 483 may be extended and retracted remotely using conventional technology such as hydraulics, pneumatics or motorized threaded actuators, for example. Similarly, as will now be described with reference to FIGS. 9A to 9H, extension and retraction of hot connector assembly 450, as a unit, onto manifold stinger assembly 410 may also be enabled remotely.

FIG. 9A illustrates perspective and elevation views of an embodiment of universal positioning system (UPS) assembly 500 deployed on the embodiment of hot connector assembly 450 of FIGS. 8A and 8B. FIGS. 9B through 9D illustrate UPS assembly 500 from FIG. 9A setting hot connector assembly 450 in various positional states of extension and retraction to assist remote connection to manifold stinger assembly 410 (omitted for clarity). FIGS. 9E through 9H illustrate UPS assembly 500 from FIG. 9A setting hot connector assembly 450 in various vertical/horizontal positional states to assist remote connection to manifold stinger assembly 410 (omitted for clarity).

FIGS. 9A through 9H together illustrate the following parts and features of UPS assembly 500:
Frame 510
Arm 515
Pivot 520
Sliding connection 525
Positioning connection 530

Referring first to FIG. 9A, UPS assembly 500 includes frame 510 rigidly fixed to pumping unit 10. Hot connector assembly 450 is shown disposed to float with respect to pumping unit 10. Conventional piping fittings such as swivel joints, for example, enable hot connector assembly 450 to float with respect to pumping unit 10 while still connected with pumping unit 10 for future fluid flow communication. Hot connector assembly 450 is connected to frame 510 via arms 515, pivots 520, sliding connections 525 and positioning connections 530. Positioning connections 530 connect hot connector assembly 450 to pivots 520. Arms 515 connect pivots 520 on hot connector assembly 450 to pivots 520 on sliding connections 525. Sliding connections 525 are slidably connected to frame 510.

It will be appreciated that sliding connections 525 and pivots 520 may be remotely actuated. Actuation may be by conventional technology such as hydraulics, pneumatics or motorized threaded actuators, for example. FIGS. 9B, 9C and 9D illustrate UPS assembly 500 from FIG. 9A setting hot connector assembly 450 in various positional states of extension and retraction via actuation of sliding connections 525 and selected pivots 520. In this way, hot connector assembly 450 may be remotely extended towards and retracted away from manifold stinger assembly 410 (not illustrated) in order to enable connection or disconnection of DMLS 400 per description of FIGS. 8A and 8B above.

FIGS. 9E, 9F, 9G and 9H illustrate UPS assembly 500 from FIG. 9A setting hot connector assembly 450 in various vertical/horizontal positional states via actuation of selected pivots 520. In this way, hot connector assembly 450 may be remotely positioned to align with manifold stinger assembly 410 (not illustrated). In other, non-illustrated embodiments of UPS 500, additional pivots (preferably at least six independent sets of pivots) may further enable remote tiling of hot connector assembly 450. In such non-illustrated embodiments, remote positioning of hot connector assembly 450 per FIGS. 9E through 9H and additional remote tilting of hot connector assembly 450 will be understood to enable remote coaxial alignment of hot connector assembly 450 with manifold stinger assembly 410 (not illustrated). Coaxial alignment promotes smooth connection and disconnection of DMLS 400 as hot connector assembly 450 is remotely extended towards and retracted away from manifold stinger assembly 410 (not illustrated).

Referring back now to FIG. 2B, the remote connection and disconnection of DMLS 400 per description above with respect to FIGS. 7 through 9H allows safe disconnection and reconnection of a pumping unit 10 from/to manifold M1 without depressurizing Manifold M1. High-pressure flow of proppant from manifold M1 to FDU 100 need not been interrupted. It is not necessary for field personnel to enter the “hot zone”. All disconnection and reconnection work may be done remotely.

FIGS. 10A and 10B are flow charts illustrating an exemplary procedures disconnecting and connecting a pumping unit 10 from/to manifold M1 in accordance with embodiments described in this disclosure. FIGS. 11A and 11B are flow charts illustrating disconnection and connection of DMLS 400 (that is, disconnection and connection of hot connector assembly 450 from/to manifold stinger assembly 410. The following paragraphs should be read in conjunction with FIGS. 10A through 11B. The following paragraphs set forth an exemplary disconnect (decoupling) sequence and an exemplary reconnect (coupling) sequence in order to replace a pumping unit 10 per FIG. 2B, for example, without depressurizing manifold M1 and interrupting pressurized fluid flow mid-stage. The following paragraphs are intended to complement the foregoing description of exemplary embodiments with reference to FIGS. 2A through 8B and FIGS. 9A through 9H. Refer particularly to FIG. 4 and its associated description above for support for the following paragraphs' description of exemplary disconnect and reconnect sequences. Periodic reference is also made below to part numbers shown on FIGS. 2A through 8B and FIGS. 9A through 9H.

### Disconnect (Decoupling) Sequence

Refer also to disconnect sequences 1000, 1100 on FIGS. 10A and 11A.
1. Signal from site control to disengage specific pumping unit 10.
   a. Shut down engine of pumping unit 10 (block 1001 on FIG. 10A) and verify zero fluid flow capability through HP hot valve 614.
2. Shut off HP hot valve 614 (also including redundant HP hot valve if extant) (block 1002 on FIG. 10A).
   a. Verify HP hot valve 614 is fully closed.
3. Open HP dump valve 616 and dump high pressure line to atmosphere (block 1003 on FIG. 10A).
4. Shut off LP hot valve 664 (block 1004 on FIG. 10A).
   a. Verify LP hot valve 664 is fully closed.
5. Open LP dump valve 666 and dump low pressure line to atmosphere (dump LP lines B [668], C [670] and D [672] on FIG. 4 to atmosphere) (block 1005 on FIG. 10A).
   a. Verify all pressure lines are at atmospheric on pumping unit 10 side of HP hot valve 614 and LP hot valve 664.
6. Disconnect DMLS assembly 400 (block 1006 on FIG. 10A) (that is, disconnect hot connector assembly 450 from manifold stinger assembly 410 per disconnect sequence 1100 on FIG. 11A).
   a. Retract actuator ring 481 to release locking elements 467 from retention (block 1101 on FIG. 11A).
   b. Retract locking ring 462 to allow locking elements 467 to dilate clear of stinger enlarged OD section 425 (block 1102 on FIG. 11A).
   c. Break seal between stinger seal surface 427 and hot connector seal surface 458 so that hot connector assembly 450 is released from manifold stinger assembly 410 (block 1103 on FIG. 11A).
   d. Retract hot connector assembly 450 from manifold stinger assembly 410 (block 1104 on FIG. 11A).
   e. Unplug electronics umbilical if extant (block 1007 on FIG. 10A).
7. Remove decoupled pumping unit 10 (block 1008 on FIG. 10A).

### Reconnect (Coupling) Sequence

Refer also to connect sequences 1050, 1150 on FIGS. 10B and 11B.
8. Bring replacement pumping unit 10 into vacant location.
9. Position pumping unit 10 so that its hot connector assembly 450 is in robotic range to be received by manifold stinger assembly 410 (block 1051 on FIG. 10B).
10. Actuate UPS assembly 500 to align hot connector assembly 450 to manifold stinger assembly 410.
   a. Robotic positioning.
   b. Alignment sensing via control feedback to hot connector assembly 450 (e.g. radar, sonar, lidar, etc.)
11. Connect DMLS assembly 400 (block 1052 on FIG. 10B) (that is, connect hot connector assembly 450 to manifold stinger assembly 410 per connect sequence 1150 on FIG. 11B).
   a. Align connector assembly 450 and manifold stinger assembly 410 (block 1151 on FIG. 11B).
   b. Engage sealing faces between stinger seal surface 427 and hot connector seal surface 458 (block 1152 on FIG. 11B)
   c. Extend locking ring 462 and then actuator ring 481 to lock DMLS 400 with high pressure seal engaged (blocks 1153 and 1154 on FIG. 11B).
   d. Address site control to recognize and pair unique ID of replacement pumping unit 10 to corresponding position/location on manifold M1 (e.g. via RFID, frequency pulse, etc.) (block 1053 on FIG. 10B).
12. Low- and High-pressure seal verification (block 1054 on FIG. 10B).
   a. Pressure test both high- and low-pressure connections.
   b. Check connection integrity, communicate to site control.
13. Human approval that pumping unit 10 can go hot on pumping unit 10 side of HP hot valve 614 and LP hot valve 664 (physical action required).
14. Ensure HP and LP dump valves 616, 666 are fully closed (block 1055 on FIG. 10B).
15. Open LP hot valve 664 (block 1056 on FIG. 10B).
   a. Verify LP hot valve 664 is fully open (e.g. via switch) and acknowledge low pressure increase (e.g. via transducer).
16. Open prime loop PL and circulate low pressure fluid through prime loop PL.
17. Close prime loop PL (block 1057 on FIG. 10B).
18. Build pressure in HP lines A-B (612, 618) to near pressure extant in manifold M1 (block 1058 on FIG. 10B).
   a. Pumping unit 10 begins to build pressure.
   b. Monitor pressure, set cap at desired pressure level.
19. Open HP hot valve 614 (block 1059 on FIG. 10B).
   a. Human interaction—Decision to include pressure pumper into the Frac system.
   b. Activate opening of HP hot valve 614.
20. Plug in electronics umbilical if extant.
21. Pumping unit 10 is online.

The scope of this disclosure in no way limits the described DMLS design embodiments and associated seal embodiments to specific sizes or models. Currently envisaged embodiments make the disclosed technology available in several sizes, shapes, and pressure ratings to adapt to desired applications. Proprietary connections may require specialized adapters. It will be nonetheless understood that the scope of this disclosure is not limited to any particular sizes, shapes, and pressure ratings for various embodiments thereof, and that the embodiments described in this disclosure are exemplary only.

Currently envisaged embodiments of the fluid connection designs (and associated seals) provide pressure ratings up to and including at least 15,000 psi MAWP. Currently envisaged sizes include internal diameters up to and including at least 8″ ID. The foregoing sizes and performance metrics are exemplary only, and the scope of this disclosure is not limited in such regards.

Although fluid connection embodiments and associated seal embodiments have been described in this disclosure with reference to an exemplary application in hydraulic fracturing at a wellhead, alternative applications could include, for example, areas such as subsea connections, deep core drilling, offshore drilling, methane drilling, open hole applications, well pressure control, wireline operations, coil tubing operations, mining operations, and various operations where remote connections are needed under a suspended or inaccessible load (i.e., underwater, hazardous area). The scope of this disclosure is not limited to any particular application in which the described fluid connections may be deployed.

Exemplary materials used in the construction of the disclosed embodiments include high strength alloy steels, high strength polymers, and various grades of elastomers.

Although the material in this disclosure has been described in detail along with some of its technical advantages, it will be understood that various changes, substitutions and alterations may be made to the detailed embodiments without departing from the broader spirit and scope of such material as set forth in the following claims.

We claim:

1. A dynamic manifold locking system (DMLS), comprising:
a stinger assembly, the stinger assembly providing separate first and second stinger flow passages therethrough, the stinger assembly further providing a stinger seal surface, the stinger assembly further providing a stinger tapered engagement surface disposed on an exterior surface of the stinger assembly;
a connector assembly configured to receive the stinger assembly, the connector assembly providing separate first and second connector flow passages therethrough, the connector assembly further providing a connector seal surface, the connector assembly further providing a locking ring and a plurality of rotatable locking elements;
wherein, when the stinger assembly is received inside the connector assembly such that the stinger seal surface sealingly engages the connector seal surface, extension of the locking ring causes the locking elements to constrict towards the stinger tapered engagement surface and thereby conjoin the stinger assembly within the housing assembly;
wherein, responsive to said conjoining of the stinger assembly and the connector assembly, the first stinger flow passage becomes continuous with the first connector flow passage and the second stinger flow passage becomes continuous with the second connector flow passage.

2. The DMLS of claim 1, in which the first stinger flow passage is located centrally within the stinger assembly.

3. The DMLS of claim 2, in which the second stinger flow passage is located annularly around the first stinger flow passage.

4. The DMLS of claim 1, in which the first stinger flow passage is configured to transfer fluid at a different pressure than fluid transferred in the second stinger flow passage.

5. The DMLS of claim 1, in which the connector assembly further includes an actuator ring and plurality of rotatable actuator elements, and in which extension of the actuator ring causes the actuator elements to constrict towards the locking elements and thereby retain the locking elements.

6. The DMLS of claim 1, in which said reception of the stinger assembly into the connector assembly is via remotely-actuated positioning of the connector assembly.

7. The DMLS of claim 1, in which said extension of the locking ring is actuated remotely.

8. The DMLS of claim 5, in which said extension of the actuator ring is actuated remotely.

9. A dynamic manifold locking system (DMLS), comprising:
a stinger assembly, the stinger assembly providing separate first and second stinger flow passages therethrough, the stinger assembly further providing a stinger seal surface, the stinger assembly further providing a stinger tapered engagement surface disposed on an exterior surface of the stinger assembly;
a connector assembly configured to receive the stinger assembly, the connector assembly providing separate first and second connector flow passages therethrough, the connector assembly further providing a connector seal surface, the connector assembly further providing a locking ring and a plurality of rotatable locking elements;
wherein, when remotely-actuated positioning of the connector assembly causes the stinger assembly to be received inside the connector assembly such that the stinger seal surface sealingly engages the connector seal surface, extension of the locking ring causes the locking elements to constrict towards the stinger tapered engagement surface and thereby conjoin the stinger assembly within the housing assembly;
wherein, responsive to said conjoining of the stinger assembly and the connector assembly, the first stinger flow passage becomes continuous with the first connector flow passage and the second stinger flow passage becomes continuous with the second connector flow passage.

10. The DMLS of claim 9, in which the first stinger flow passage is located centrally within the stinger assembly.

11. The DMLS of claim 10, in which the second stinger flow passage is located annularly around the first stinger flow passage.

12. The DMLS of claim 9, in which the first stinger flow passage is configured to transfer fluid at a different pressure than fluid transferred in the second stinger flow passage.

13. The DMLS of claim 9, in which the connector assembly further includes an actuator ring and plurality of rotatable actuator elements, and in which extension of the actuator ring causes the actuator elements to constrict towards the locking elements and thereby retain the locking elements.

14. The DMLS of claim 9, in which said extension of the locking ring is actuated remotely.

15. The DMLS of claim 13, in which said extension of the actuator ring is actuated remotely.

16. A dynamic manifold locking system (DMLS), comprising:
a stinger assembly, the stinger assembly providing separate first and second stinger flow passages therethrough, the stinger assembly further providing a stinger seal surface, the stinger assembly further providing a stinger tapered engagement surface disposed on an exterior surface of the stinger assembly;
a connector assembly configured to receive the stinger assembly, the connector assembly providing separate first and second connector flow passages therethrough, the connector assembly further providing a connector seal surface, the connector assembly further providing a locking ring and a plurality of rotatable locking elements;
wherein, when remotely-actuated positioning of the connector assembly causes the stinger assembly to be received inside the connector assembly such that the stinger seal surface sealingly engages the connector seal surface, remotely-actuated extension of the locking ring causes the locking elements to constrict towards the stinger tapered engagement surface and thereby conjoin the stinger assembly within the housing assembly;
wherein, responsive to said conjoining of the stinger assembly and the connector assembly, the first stinger flow passage becomes continuous with the first connector flow passage and the second stinger flow passage becomes continuous with the second connector flow passage.

17. The DMLS of claim 16, in which the first stinger flow passage is located centrally within the stinger assembly.

18. The DMLS of claim 17, in which the second stinger flow passage is located annularly around the first stinger flow passage.

19. The DMLS of claim 16, in which the first stinger flow passage is configured to transfer fluid at a different pressure than fluid transferred in the second stinger flow passage.

20. The DMLS of claim 19, in which the connector assembly further includes an actuator ring and plurality of rotatable actuator elements, and in which remotely-actuated extension of the actuator ring causes the actuator elements to constrict towards the locking elements and thereby retain the locking elements.
